(19) United States
(12) Patent Application Publication
(10) Pub. No.: US 2013/0268449 A1
(43) Pub. Date: Oct. 10, 2013

(54) MOBILITY DEVICE TRACKING SYSTEMS AND METHODS

(71) Applicant: Craig Mateer, Orlando, FL (US)

(72) Inventor: Craig Mateer, Orlando, FL (US)

(21) Appl. No.: 13/443,521

(22) Filed: Apr. 10, 2012

(51) Int. Cl. G06Q 10/00

(52) U.S. Cl. 705/317

(57) ABSTRACT

Methods and systems for mobility device tracking within a facility. Device information is received, stored and updated. The location is tracked within the facility. Information related to interactions with the mobility device are stored. A compliance report is generated based on the stored interaction information.

### BACKGROUND

The present disclosure relates generally to systems and methods for tracking mobility devices and more particularly, to tracking a mobility device within a facility and generating a compliance report based on interactions with the mobility device.

### SUMMARY

The disclosure relates to mobility device tracking techniques. In one implementation, in general, a computer-implemented method includes receiving, at a server, device information corresponding to a wheelchair, wherein the device information comprises a location identifier and a device identifier. The method may also include storing or updating the device information in a memory. The method may include tracking a location of the wheelchair within a facility as the wheelchair changes position within the facility. The method may yet further include storing information related to interactions with the wheelchair, wherein the interactions comprise scanning the location identifier and the device identifier at timed intervals for facilitating compliance with regulations. The method may also include generating a compliance report based on the stored interaction information.

In another implementation, in general, the method may be performed by a processor including, receiving, at the processor, device information corresponding to a mobility device. The method may also include tracking a location of the mobility device within a facility. The method may include storing information related to interactions with the mobility device, wherein the interactions comprise scanning the device information at timed intervals for facilitating compliance with regulations. The method may also include generating a compliance report based on the stored interaction information.

In another implementation, in general, a system for monitoring a mobility device location and a user of the mobility device may include a tangible computer-readable storage device comprising instructions; and a processor coupled to the tangible computer-readable device and configured to execute the instructions to perform operations. The operations may include receiving, at a server, device information corresponding to the mobility device, wherein the device information may include a location identifier, a device identifier, and a user identifier. The operations may also include determining a direction of the mobility device and tracking the mobility device location using location detectors. The operations may include storing information related to interactions with the mobility device, wherein the interactions comprise scanning the location identifier, the device identifier and the user identifier at timed intervals for facilitating compliance with state and federal regulations. The operations may also include generating a compliance report based on the stored interaction information.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of a system in accordance with a described implementation;

FIG. 2 is an illustration of a map in accordance with a described implementation;

FIG. 3 is a diagram of providing a notification in accordance with a described implementation; and

FIG. 4 is a diagram of providing a compliance report in accordance with a described implementation.

Like reference numbers and designations in the various drawings indicate like elements.

### DETAILED DESCRIPTION

A wheelchair attendant tracking and dispatching system and method is disclosed herein. The system and method captures data and the performance in a services industry, e.g., an airport service. Real-time tracking and monitoring of requests for mobility devices (e.g., wheelchairs), dispatching of mobility devices, and reporting to verify all service details (e.g., compliance with a regulation). The data may be utilized for operational and scheduling efficiencies, which may result in lower costs for an industry such as the airline industry.

An advantage of the tracking system and method disclosed herein is the service accountability by attendants/operators of mobility devices. It is a passenger-service design that may use tracking technologies along with barcode location scanning for tracking and reporting of services provided. The dispatching and tracking of mobility devices is important for a variety of companies. For example, the number of mobility devices, the location of mobility devices, etc. are important parameters for companies to track.

Companies may also want to monitor the users of the mobility device. The users of the mobility device may include passengers or operators of the mobility device. For example, the company may want to monitor whether an operator of the mobility device is taking the most efficient route while navigating the mobility device. The importance of monitoring the mobility device (e.g., the location, the passenger, etc.) may also be pivotal for a company to comply with regulations. In general, regular monitoring may need to be recorded and stored to ensure compliance with local, state, or federal rules.

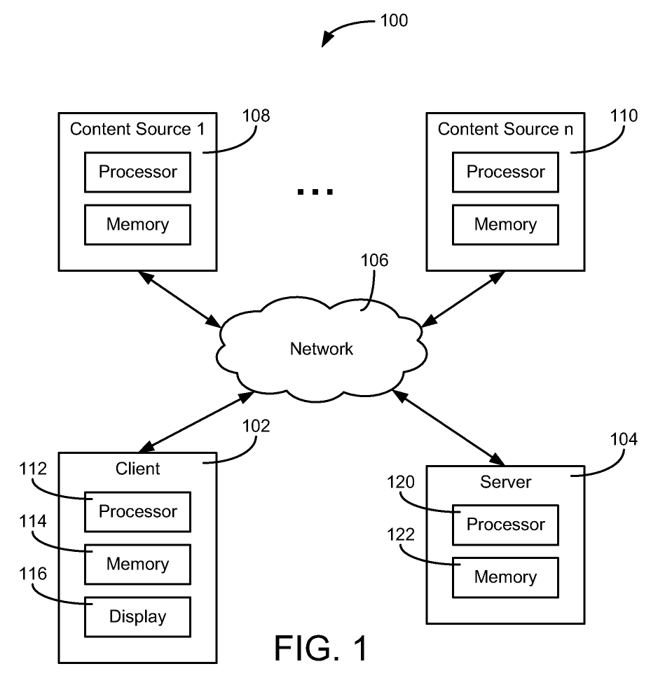

Referring to FIG. 1, a block diagram of a computer system 100 in accordance with a described implementation is shown. System 100 includes client 102, which may communicate with other computing devices via network 106. For example, client 102 may communicate with content source 108, 110 to receive webpages and/or media content (e.g., audio, video, and other forms of digital content). System 100 may also include server 104, which provides data to other computing devices over network 106.

Network 106 may be any form of computer network that relays information between client 102, server 104, and content sources 108, 110. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CAT5 cable, etc.) to other computing devices in network 106.

Client 102 may be any number of different user electronic devices configured to communicate via network 106 (e.g., a hand-held computer (scanner), a laptop computer, a desktop computer, a tablet computer, a smartphone, a digital video recorder, a set-top box for a television, a video game console, etc.). Client 102 is shown to include processor 112 and memory 114, i.e., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Client 102 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which visually displays webpages using webpage data received from content sources 108, 110 and/or from server 104.

Content sources 108, 110 are electronic devices connected to network 106 and provide media content to client 102. For example, content sources 108, 110 may be computer servers (e.g., FTP servers, file sharing servers, web servers, etc.) or other devices that include a processing circuit. Content may include, but is not limited to, webpage data, a movie, a sound file, pictures, and other forms of data. Similarly, server 104 may include a processing circuit including processor 120 and memory 122. In some implementations, server 104 may include several computing devices (e.g., a data center, a network of servers, etc.). In such a case, the various devices of server 104 may be in electronic communication, thereby also forming a processing circuit (e.g., processor 120 includes the collective processors of the devices and memory 122 includes the collective memories of the devices).

Server 104 may provide information to client 102 via network 106. For example, content source 108 may provide content to client 102, in response to receiving a request for content from client 102. In some implementations, content from content server 104 may be provided to client 102 indirectly. For example, content source 108 may receive data from server 104 and use the data as part of the content provided to client 102. In other implementations, data from server 104 may be provided to client 102 directly. For example, content source 108 may provide webpage data (e.g., rules related to compliance) to client 102 that includes a command to retrieve data (e.g., compliance report) from server 104. On receipt of the webpage data, client 102 may retrieve the compliance report from server 104 based on the command and display the compliance report when the webpage is rendered on display 116.

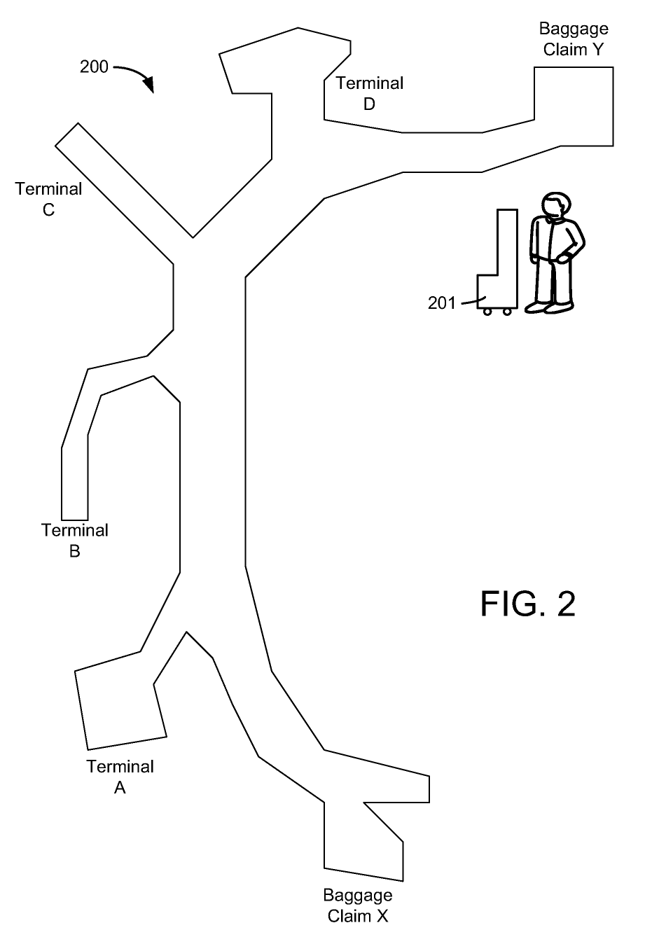

FIG. 2 illustrates an example of facility map 200 in accordance with a described implementation. Facility map 200 may be provided by content sources 108 or 110 and/or server 104 to client device 102.

Facility map 200 may be displayed on client device 102 via a browsing application (e.g., as webpage data). Facility map 200 may be downloaded as an application on client device 102. For example, an operator of the mobility device may download facility map 200 on client device 102. Facility map 200 may be updated by server 104, content source 108, etc. In some implementations, facility map 200 may be updated based on the passenger of the mobility device. For example, the passenger's airline ticket may be scanned and facility map 200 may be updated according to the passenger's preferences and destination.

The facility depicted in facility map 200 may include, but is not limited to, schools, campuses, hospitals, etc. As an example, facility map 200 is a map of an airport. Facility map 200 includes a number of concourses as well as the location of the baggage claims. For purposes of the disclosure, facility map 200 denotes locations where the location of mobility device 201 may be scanned. For example, when mobility device 201 enters Terminal A, the location of mobility device 201 can be scanned. The location of mobility device 201 can be scanned at other locations that are not depicted in facility map 200. For example, airport gates, bathrooms, security points, concession stands, etc., are locations that can be scanned and associated with mobility device 201. In some implementations, the location of mobility device 201 may not be determined using Wi-fi triangulation or global positioning information, because of certain limitations that are present within the facility. In these implementations, certain locations within the facility may be scanned in order to determine location, record data, etc. with regard to mobility device 201. For example, each scannable location can have a barcode. Client 102 can scan the barcode using a known barcode scanner. Timestamps can also be captured that indicate the time a particular scan or scans took place.

Scanning the location of a mobility device throughout an airport can provide a data trail that can be use to show compliance with federal, state, local, company, etc. regulations. For example, a user can request a mobility device upon arrival at an airport at an attendant station. At that time an attendant can use client 102 to scan a barcode associated with the user and a location bar code associated with the attendant station. The barcode associated with the user can be located on the user's ticket, boarding pass, etc. and/or the mobility device. The attendant or another attendant can then help the user navigate through the airport. At various locations, the attendant can rescan the barcode associated with the user and scan a location barcode. For example, as the user enters Terminal B, a barcode associated with Terminal B can be scanned. The location, as well as the time of the scan, can be stored in the client 102 and/or sent to the server 104.

Eventually, the user arrives at a gate corresponding with their flight. The barcode associated with the user and the gate can be scanned. The attendant may then leave the user at the gate. Regulations may require that an attendant checks with the user at various time intervals. In one implementation, alerts can be generated and sent to attendants regarding a user associated with an upcoming check in time. For example, regulations may require that users of mobility devices be checked every thirty minutes. Continuing our example from above, an alert can be generated 5, 10, 15, etc. minutes prior to an approaching deadline for the user waiting at the gate. The alert can be sent to one or more of the attendants that have previously scanned in data associated with the user. The alert can also be sent to attendants that are located near the user's last known position, e.g., the gate. The alert can include the last known location of the user as well as the time of the upcoming deadline. Upon receipt of the alert, an attendant can indicate the they will check the user prior to the deadline. This indication can then be sent to any other attendant that received the alert to indicate that the user will be check with prior to the deadline. The attendant can then locate the user, scan the bar code associated with the user, and scan a barcode associated with the user's current location.

The various location data can also be associated with a particular attendant. In one implementation, each client 102 is associated with an attendant. For example, an attendant may have to login to the client 104. In this example, login information, e.g., a username, etc., can be used to identify a particular employee. In another implementation, in addition to scanning a barcode associated with a user and a barcode associated with a location, an attendant can also scan a barcode associated with the attendant. For example, an attendant's employee badge can have a barcode that can be scanned. This barcode can identify the particular attendant. The data that identifies the attendant can be stored along with the various location data on the client 102 or sent to the server 104.

The attendants can scan in the various barcodes using the client 102. The client 102 can store the scanned data and can transmit the data associated with the user to the server 104. As described below, compliance reports can be generated from the data stored on the server 104. Using the timestamps, the scanned location data, and attendant data, a compliance report can indicate the movement of the user through the airport as well as the interactions of various attendants with the user. This data can be compared to various regulations to determine compliance with the regulations. In one implementation, the server 104 interfaces with one or more computers associated with an airline. Data associated with users of that airline can then be transferred to the airline's computers. Compliance reports can then be generated using the data located on the airline's computers.

Certain locations within the facility may include location detectors. The location detectors may be located throughout the facility at known locations for receiving mobility device 201 information. For example, within an airport, each terminal, gate, restroom, etc. may include a location detector. In some implementations, the location detectors are wired to server 104 or in wireless communication with server 104. Server 104 processes the device information received from the location detectors or mobility device 201. In some implementations, the device information may include the location of mobility device 201, the status of mobility device 201 (e.g., passenger, battery life, etc.), and other factors that may be monitored. The device information may also be provided to client device 102.

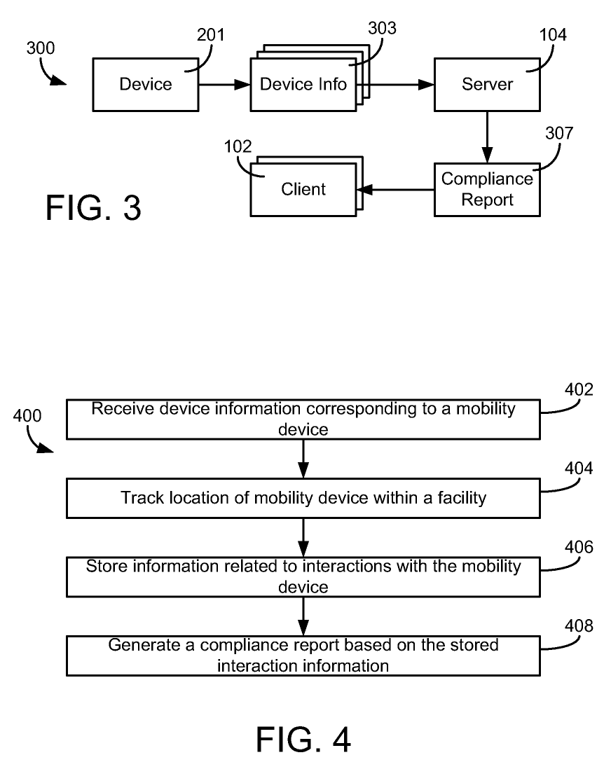

FIG. 3 is an illustration of a system 300 for generating a compliance report in accordance with a described implementation. System 300 includes device 201, device information 303, database 305, server 104, compliance report 307 and client 102. In a brief overview, system 300 monitors the device location and a user of the device to generate a compliance report.

In a non-limiting example, device 201 may include a mobility device. For example, the mobility device may be a wheel chair. Device 201 may include any device that many be monitored. Device information 303 may include a location identifier, a device identifier, a user identifier, etc.

The location identifier may include a tag that periodically transmits a unique identification signal. The location identifier may be transmitted by a location within the facility via the location detector. In some implementations, the location detector transmits the location identifier to mobility device 201 or client 102.

Client 102 or mobility device 201 may transmit the location identifier along with other device information (e.g., the user identifier and device identifier) to server 104. The user identifier may include information related to the passenger, the operator, etc. of mobility device 201. For example, the user identifier may include information such as name, preferences, medical conditions, etc. In some implementations, the user identifier may be provided to client 102 or mobility device 201 via scanning of a passenger ticket. The device identifier may include information related to the model, size, type, features of mobility device 201. For example, the device identifier can include information related to the battery life of the mobility device 201.

In other implementations, the location detector transmits the location identifier to server 104. Server 104 receives the location identifier along with device information (e.g., the user identifier and the device identifier) to determine location of mobility device 201. In some implementations, server 104 may transmit information to client device 102 or mobility device 201.

In some implementations, the information provided to client device 102 may include compliance report 307. For example, compliance report 307 may provide details to the operator of mobility device 201 on how to comply with local, state, or federal regulations. Regulations may include any law, rule, order, etc. that is designed to regulate conduct. The information may also include alerts, warnings, etc. designed to get the attention of the operator if an action should be or should not be taken. For example, mobility device 201 or client device 102 may signal (e.g., audio, visual, tactile, etc.) to the operator that the passenger of mobility device 201 has to be monitored at regular intervals.

FIG. 4 is an example of a method 400 for generating a compliance report. Method 400 may be implemented by a server or other computing device having access to some or all of the device information.

Method 400 may include receiving device information corresponding to a mobility device (block 402). The device information may be received by a server, a processor, or any other appropriate receiving tool. The mobility device may include any passenger handling device, e.g., a wheelchair. The device information may include a location identifier and a device identifier. In some implementations, the location identifier may include at least a vertex, a coordinate, longitude or latitude information corresponding to a textual description of a mobility device location. In other implementations, the location identifier may include a position of the mobility device. For example, the position can be along a start point and an end point of a predetermined route.

Method 400 may include tracking a location of the mobility device within a facility (block 404). In some implementations, tracking the location includes determining the direction of the mobility device. For example, determining the direction of the mobility device may include predicting a directional tendency of the mobility device. In an example, the system may track the location by predicting the most likely path that the mobility device will likely take between two points.

Method 400 may include storing information related to interactions with the mobility device (block 406). The interactions may include scanning the device information at timed intervals. The device information may be scanned in order to facilitate compliance with regulations. Method 400 may further include updating device information related to interactions with the mobility device.

Method 400 may include generating a compliance report based on the stored interaction information (block 408). The compliance report may be displayed to an operator of the mobility device. For example, the compliance report may be displayed on a client device. In some implementations, the compliance report may include audio, visual, tactile and any other appropriate form of feedback. A notification may be provided to the operator of the mobility device related to the compliance of the interactions with the mobility device. As a non-limiting example, an audible signal may alert the operator that the passenger of the mobility device must be observed to comply with a regulation.

Method 400 may include receiving a user identifier. The user identifier may be associated with the passenger of the mobility device. In some implementations, the user identifier is received from a client device. For example, the operator may have a hand-held scanner that is used to receive the user identifier from a passenger's ticket, license, etc. The user identifier may include a user name, a user preference or a user medical condition.

Method 400 may also include providing a user interface for an operator to select an action from a list of actions to facilitate compliance with a regulation. For example, the user interface may be a pop-up window on the client device 102. In some implementations, the user interface displays a number of ways to comply with the regulation such as checking on the passenger, verifying the passenger's terminal (e.g., if the passenger has dementia), etc.

Implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer implemented method comprising:
receiving, at a server, device information corresponding to a wheelchair, wherein the device information comprises a location identifier and a user identifier;
storing or updating the device information in a memory;
tracking a location of the wheelchair within a facility as the wheelchair changes position within the facility;
storing information related to interactions with the wheelchair, wherein the interactions comprise scanning the location identifier and the user identifier at timed intervals for facilitating compliance with regulations; and
generating a compliance report based on the stored interaction information.

2. A method performed by a processor comprising:
receiving, at the processor, device information corresponding to a mobility device;
tracking a location of the mobility device within a facility;
storing information related to interactions with the mobility device, wherein the interactions comprise scanning the location information at timed intervals for facilitating compliance with regulations; and
generating a compliance report based on the stored interaction information.

3. The method of claim 2, wherein the mobility device is a wheelchair.

4. The method of claim 2, wherein the location information comprises a location identifier, and wherein the interactions further comprise scanning user information and attendant information.

5. The method of claim 4, wherein the location identifier comprises at least vertex, coordinate, longitude or latitude information corresponding to a textual description of the mobility device location.

6. The method of claim 4, wherein the location identifier comprises a position, the position along a start point and an end point of a predetermined route.

7. The method of claim 2, further comprising determining the direction of the mobility device by predicting a directional tendency of the mobility device.

8. The method of claim 2, further comprising storing or updating the location information.

9. The method of claim 2, further comprising displaying the compliance report to an operator of the mobility device.

10. The method of claim 2, further comprising providing a notification to an operator of the mobility device related to the compliance of the interactions of the mobility device.

11. The method of claim 2, further comprising:
receiving a user identifier, wherein the user identifier comprises at least one of a user name, a user preference, and a user medical condition.

12. The method of claim 2, further comprising providing a user interface for an operator to select an action from a list of actions to facilitate compliance with the regulations.

13. A system for monitoring a mobility device location and a user of the mobility device comprising:
a tangible computer-readable storage device comprising instructions; and
a processor coupled to the tangible computer-readable device and configured to execute the instructions to perform operations comprising:
receiving, at a server, device information corresponding to the mobility device, wherein the device information comprises a location identifier, an attendant identifier, and a user identifier;
storing information related to interactions with the mobility device, wherein the interactions comprise scanning the location identifier, the attendant identifier and the user identifier at timed intervals for facilitating compliance with state and federal regulations; and
generating a compliance report based on the stored interaction information.

14. The system of claim 13, wherein the location identifier comprises at least vertex, coordinate, longitude or latitude information corresponding to a textual description of the mobility device location.

15. The system of claim 13, wherein the location identifier comprises a position, the position along a start point and an end point of a predetermined route.

16. The system of claim 13, wherein the operations further comprise determining a direction of the mobility device by predicting a directional tendency of the mobility device.

17. The system of claim 13, further comprising displaying the compliance report to an operator of the mobility device.

18. The system of claim 13, further comprising providing a notification to an operator of the mobility device related to the compliance of the interactions of the mobility device.

19. The system of claim 13, wherein the user identifier comprises at least one of a user name, a user preference, and a user medical condition.

20. The system of claim 13, further comprising providing a user interface for an operator to select an action from a list of actions to facilitate compliance with state and federal regulations.
